(19) United States
(12) Patent Application Publication
(10) Pub. No.: US 2025/0138506 A1
(43) Pub. Date: May 1, 2025

(54) PLACEMENT IDENTIFYING APPARATUS

(71) Applicant: OKUMA Corporation, Niwa-gun (JP)

(72) Inventors: Shigemoto HIROTA, Niwa-gun (JP); Katsunori KUNIMITSU, Niwa-gun (JP); Keigo ASANO, Niwa-gun (JP)

(21) Appl. No.: 18/919,637

(22) Filed: Oct. 18, 2024

(30) Foreign Application Priority Data
Oct. 26, 2023 (JP) 2023-184247

(51) Int. Cl. G05B 19/401; G06T 7/00; G06T 7/73; H04N 23/63

(52) U.S. Cl. CPC G05B 19/401; G06T 7/001; G06T 7/73; H04N 23/631

(57) ABSTRACT

A placement identifying apparatus includes: a camera that captures an image of a target; an UI apparatus; and a controller configured to identify a placement of a measurement target. The controller is configured to: store in advance a reference image representing a shape of a reference target; identify a provisional placement of the measurement target based on a position identifying image which is a captured image of the measurement target; preliminarily adjust a position and an angle of the reference image based on the provisional placement, and generate an overlap image which is an image in which the reference image is overlapped over the position identifying image; receive from a user command of fine adjustment for the position and the angle of the reference image; and identify a true placement of the measurement target based on the reference image after the fine adjustment.

### CROSS REFERENCE TO RELATED APPLICATION

The present invention claims priority under 35 U.S.C. § 119 to Japanese Patent Application No. 2023-184247 filed on Oct. 26, 2023, the entire contents of which being incorporated herein by reference.

### TECHNICAL FIELD

The present disclosure relates to a placement identifying apparatus which identifies a placement of a measurement target which is set in a predetermined area.

### BACKGROUND

In the related art, there have been demands to identify placement of a target which is set at an arbitrary placement. For example, when a workpiece is machined with a machine tool, an operator sets the workpiece, which is a machining target, in a machining chamber. In this process, a position and an angle of the workpiece may deviate from a reference position and a reference angle which are defined in advance. When the placement of the workpiece is deviated from the reference, there is a possibility that a movable part (such as, for example, a tool) of the machine tool unexpectedly interferes with the workpiece.

In consideration of this, in the related art, the operator measures the placement of the workpiece prior to machine-processing by the machine tool. The measurement is done, for example, by manually or automatically manipulating a touch probe attached to the movable part of the machine tool. However, there has been a problem in such a measurement using the touch probe, in that the measurement requires a long period of time.

In addition, there have been some proposals of a technique of detecting the placement of the workpiece by capturing an image of a workpiece which is set and analyzing the acquired captured image of the workpiece. For example, JP 2010-078513 A discloses a technique in which a pattern matching process is applied to a captured image of a workpiece which is captured by a camera, so as to calculate an approximate position of the workpiece, and then a more accurate position is calculated using a characteristic region of the workpiece.

JP H7-110217 A discloses a technique in which a captured image of a workpiece is analyzed to identify a position of the center of gravity of the workpiece and a characteristic point of the workpiece, and an angle of the workpiece is determined based on an angle between the characteristic point and the center-of-gravity position.

However, in the technique using the pattern matching as in JP 2010-078513 A, it is necessary to fit the entirety of the pattern image to the entirety of the captured image of the workpiece while changing the position and the angle, and to check a degree of match. In this case, there is a problem in that the required calculation time is very long.

In the technique of JP H7-110217 A, the captured image of the workpiece is analyzed, and the angle of the workpiece is calculated. However, an error may be caused in the angle of the workpiece acquired by such an image analysis, due to fluctuation of external environment such as a degree of illumination. Because of this, in the technique of JP H7-110217 A, an error tends to be easily caused in the calculated position and the calculated angle of the workpiece. When the machine tool is operated based on the data of the position and the angle containing errors, there is a possibility that the workpiece and/or the tool is damaged.

In view of the foregoing, the present disclosure discloses a placement identifying apparatus which can identify a placement of a target more accurately and in a shorter period of time.

### SUMMARY

According to one aspect of the present disclosure, there is provided a placement identifying apparatus comprising: a camera that captures an image of a target which is placed in a predetermined area; an UI apparatus that presents information to a user and that receives a manipulation command from the user; and a controller configured to identify a placement of a measurement target, which is a target which is set at an arbitrary placement, based on an image captured by the camera, wherein the controller is configured to: store in advance a reference image representing a shape of a reference target which is a target which is set at a known placement; acquire a position identifying image by causing the camera to capture an image of the measurement target; identify a provisional placement of the measurement target based on the position identifying image; preliminarily adjust a position and an angle of the reference image based on the provisional placement so that the reference target represented in the reference image overlaps the measurement target, and generate an overlap image which is an image in which the reference image is overlapped over the position identifying image; present the overlap image to the user, and receive from the user a command of fine adjustment for the position and the angle of the reference image; and identify a true placement of the measurement target based on the position and the angle of the reference image after the fine adjustment.

In this case, the target may have a reference point and one or more characteristic parts, and the controller may be further configured to define a position of the target with reference to the reference point and define an angle of the target with reference to the one or more characteristic parts.

Further, the reference point may be a center of gravity of the target, each of the one or more characteristic parts may be a shape part which is present in an outer form of the target, and which can be distinguished from a periphery thereof, and the controller may be further configured to define the angle of the target by a direction angle of each of the one or more characteristic parts as viewed from the reference point or another characteristic part.

The reference image may be transparent to an extent that the position identifying image is visible in the overlap image.

In this case, the reference image may be a mask image in which portions other than the one or more characteristic parts in the reference target are masked.

The controller may be further configured to identify an amount of deviation between each of the one or more characteristic parts of the measurement target and a respective one of the one or more characteristic parts of the reference target in the overlap image, and to identify, when the amount of deviation is less than a predefined allowable value, the true placement of the measurement target based on the position and the angle of the reference image after the preliminary adjustment, without presenting the overlap image to the user.

The controller may be further configured to: store a size of the characteristic part and a relative position of the characteristic part with respect to the reference point in the reference target as characteristic information; identify a search range of the characteristic part of the measurement target in the position identifying image based on the characteristic information; and output a target mismatch error when no shape matching the characteristic information is found in the search range of the position identifying image.

The one or more characteristic parts may be an outer form of the target, and the controller may be further configured to define the angle of the target by an angle of inclination of the outer form of the target.

The controller may be further configured to calculate the provisional placement of the measurement target based on an image acquired by binarizing the position identifying image.

The predetermined area may be a machining chamber of a machine tool, and the target may be a workpiece which is fixed in the machining chamber, and which is to be machined by the machine tool.

According to an aspect of a placement identifying apparatus of the present disclosure, fine adjustment by the user is performed after a reference image is preliminarily adjusted. With this configuration, the placement of the workpiece can be identified in a short period of time and accurately.

### BRIEF DESCRIPTION OF DRAWINGS

Embodiment(s) of the present disclosure will be described based on the following figures, wherein:

FIG. 1 is a schematic diagram showing a structure of a placement identifying apparatus,

FIG. 2 is a schematic diagram of a reference workpiece and a workpiece to be measured,

FIG. 3 is a schematic diagram showing extraction of a center of gravity and a characteristic part,

FIG. 4 is a schematic diagram showing a position identifying image and a negative-positive-inverted image,

FIG. 5 is a diagram showing an example of a reference image,

FIG. 6 is a diagram showing a case example of a registration screen of the reference image,

FIG. 7 is a diagram showing an example of an overlap image,

FIG. 8 is a flowchart showing a first half of a procedure of machining of a workpiece to be measured by a machine tool,

FIG. 9 is a flowchart showing a second half of the procedure of machining the workpiece to be measured by the machine tool; and

FIG. 10 is a diagram showing an example of another workpiece.

### DESCRIPTION OF EMBODIMENTS

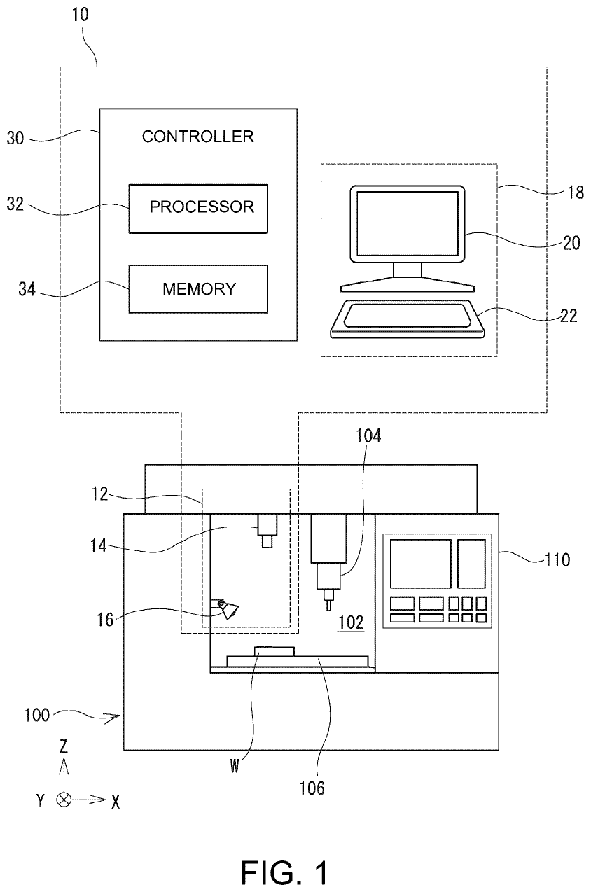

A structure of a placement identifying apparatus 10 will now be described with reference to the drawings. FIG. 1 is a schematic diagram showing a structure of the placement identifying apparatus 10. The placement identifying apparatus 10 identifies a placement of a target which is set in a predetermined area. In the present embodiment, a “placement” includes a “position” of a target in a two-dimensional plane and may also include an “angle” of the target in the two-dimensional plane. In the following, a placement identifying apparatus 10 formed in combination with a machine tool 100 will be exemplified for the description. In the placement identifying apparatus 10, the “predetermined area” is a machining chamber 102 of the machine tool 100, and the “target” is a workpiece W which is machined by the machine tool 100. However, the placement identifying apparatus 10 described herein is merely exemplary. Thus, the placement identifying apparatus 10 is not limited to be combined with the machine tool 100 and may alternatively be combined with other apparatuses. Alternatively, the placement identifying apparatus 10 may be used as a single apparatus, without being combined with another apparatus. Therefore, the “target” is not limited to the workpiece W and may alternatively be another member.

First, the machine tool 100 will be briefly described. The machine tool 100 applies machine-processing on the workpiece W according to an NC program which is commanded by a user. In the following, a machining center having a spindle head 104 will be exemplified for the description.

In the machining chamber 102 of the machine tool 100, a table 106 and the spindle head 104 for holding a tool are provided. After a human or a robot sets the workpiece W on the table 106, the human or the robot fixes the workpiece W on the table 106 using a magnet chuck, a dedicated fixation jig, or the like. An NC apparatus 110 of the machine tool 100 operates a movable part (for example, the spindle head 104) according to an NC program designated by the user, in order to machine the workpiece W.

Here, normally, the NC program is generated under a presumption that the workpiece W is set at a reference position and with a reference angle which are defined in advance. However, in reality, a slight placement error is caused in the workpiece W which is set in the machining chamber 102. When the machine tool 100 is operated without correcting such a placement error, there is a possibility that the movable part of the machine tool 100 interferes with the workpiece W, or precision of the workpiece W acquired after the completion of the machining (that is, a product) is reduced.

In order to prevent such an interference and precision reduction, normally, the user measures the placement error of the workpiece W prior to starting the machining and registers the placement error as an amount of offset in the NC apparatus 110. The NC apparatus 110 controls movement of the movable part in consideration of the input amount of offset. With this configuration, the interference between the movable part and the workpiece W is prevented, and precision of the product can be maintained at an appropriate level.

However, in the related art, there has been a problem in that time and effort are required for measuring the placement error of the workpiece W. For example, in order to measure the position and the angle of the workpiece W, a configuration may be considered in which the user operates a touch probe manually or automatically. However, the measurement using the touch probe requires time and effort. In addition, there have been some proposals of a technique for identifying the position and the angle of the workpiece W based on a captured image of the workpiece W. However, in the technique of the related art, the calculation of the position and the angle requires some time, or the precision has been low.

The placement identifying apparatus 10 identifies the position and the angle; that is, the placement, of the workpiece W. In the following description, directions parallel to a mounting surface of the workpiece W will be referred to as an X direction and a Y direction, and a direction perpendicular to the mounting surface will be referred to as a Z direction. In addition, the position and the angle of the workpiece W to be identified by the placement identifying apparatus 10 of the present embodiment are respectively a position in an XY plane of the workpiece W, and a rotational angle of the workpiece W about an axis parallel to the Z direction.

The placement identifying apparatus 10 comprises an imaging unit 12, a UI apparatus 18, and a controller 30. The imaging unit 12 captures an image of a target which is set in the machining chamber 102; that is, the workpiece W. The imaging unit 12 comprises, for example, a camera 14 and an illuminator 16 which illuminates the workpiece W. The camera 14 may be fixedly placed in the machining chamber 102 or may be attached to a position adjusting device such as a pan head and an XY table. When a position and an orientation of the camera 14 can be changed, the position and the orientation of the camera 14 are detected by a sensor and are transmitted to the controller 30. The controller 30 transforms the coordinate system between a camera coordinate system and a machine coordinate system of the machine tool 100, based on the position and the orientation of the camera 14. The number of the camera 14 is not limited to one, and alternatively, a plurality of cameras 14 may be provided.

In the present embodiment, the camera 14 is placed to oppose the mounting surface of the workpiece W (that is, an upper surface of the table 106), and has an optical axis which is approximately orthogonal to the mounting surface. The camera 14 can communicate with the controller 30 via a wire or wirelessly. The camera 14 operates according to a control signal transmitted from the controller 30. Further, the camera 14 transmits data of a captured image to the controller 30.

The illuminator 16 illuminates the workpiece W. The illuminator 16 may be fixedly placed in the machining chamber 102 or may be placed in a state in which a position and an orientation thereof can be changed. Further, the quantity of the illuminator 16 is not limited to one, and alternatively, a plurality of illuminators 16 may be provided. Similar to the camera 14, the illuminator 16 can communicate with the controller 30 via a wire or wirelessly. In the illuminator 16, an amount of light, a color temperature, and an irradiation direction are changed according to a control signal transmitted from the controller 30.

The UI apparatus 18 comprises an output device 20 which presents information to the user, and an input device 22 which receives a manipulation command from the user. In the present embodiment, the output device 20 includes a display which displays an overlap image 80 to be described later, or the like. In addition, the input device 22 includes, for example, a keyboard, a touch panel, a mouse, a microphone, a barcode scanner, or the like. The output device 20 and the input device 22 may be provided independently from the machine tool 100 or may be incorporated in the machine tool 100. For example, a manipulation panel provided on the machine tool 100 and a display of the manipulation panel may be used as the input device 22 and the output device 20 of the placement identifying apparatus 10. Each of the input device 22 and the output device 20 can communicate with the controller 30 via a wire or wirelessly.

The controller 30 identifies the placement (that is, the position and the angle) of the workpiece W based on an image of the workpiece W captured by the camera 14. Physically, the controller 30 is a computer having a processor 32 and a memory 34. The controller 30 can communicate with the NC apparatus 110 via a wire or wirelessly. FIG. 1 shows the controller 30 as a single computer independent from the NC apparatus 110. However, alternatively, the controller 30 may be formed by combining a plurality of computers which are physically separated from each other. Alternatively, the NC apparatus 110 may function as a part or all of the controller 30. In any case, the controller 30 identifies the placement of the workpiece W which is the target to be measured. The controller 30 calculates a difference between the identified placement and a reference placement which is defined in advance as an amount of offset and transmits the amount of offset to the NC apparatus 110. The NC apparatus 110 causes the movable part of the machine tool 100 to operate in consideration of the received amount of offset.

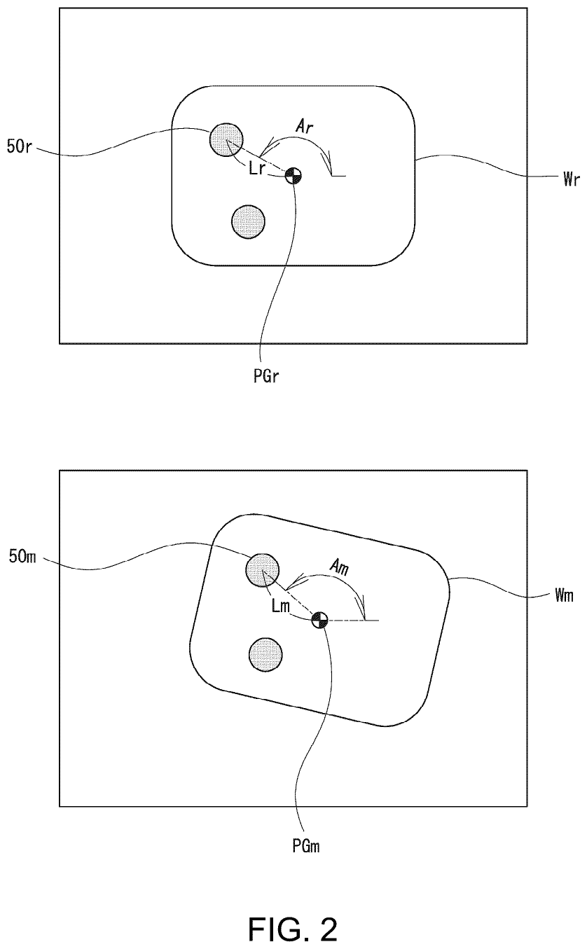

Next, identification of the placement of the workpiece W by the placement identifying apparatus 10 will be described. An upper part of FIG. 2 is a schematic diagram of a workpiece W having a known placement, and a lower part of FIG. 2 is a schematic diagram of a workpiece W which is the target to be measured, having an arbitrary placement. In the following, the workpiece W with the known placement will be called a “reference workpiece Wr”, and the workpiece W which is the target to be measured will be called a “workpiece to be measured Wm”. Further, reference numerals of elements related to the reference workpiece Wr will be shown with an index “r”, and reference numerals of elements related to the workpiece to be measured Wm will be shown with an index “m”. Moreover, when the reference workpiece Wr and the workpiece to be measured Wm are not distinguished, the indices of “r” and “m” will be omitted, and the workpiece will be simply called a “workpiece W”. This notation similarly applies to other elements.

In the present embodiment, workpiece information is set for each type of the workpiece W. The workpiece information can be roughly divided into machining information and placement information. The machining information includes a product number of the workpiece W, identification information of a machining process of the workpiece W, and identification information of an NC program to be applied to the workpiece W.

The placement information is information representing an ideal placement of the workpiece W and is information representing the placement of the reference workpiece Wr. The placement information includes a position of a reference point of the reference workpiece Wr, characteristic information, and a reference image 60 to be described later. In the present embodiment, a center of gravity PG of the workpiece W is treated as the reference point. In addition, in the present embodiment, a characteristic shape part (for example, a protrusion, a hole, or the like) of the workpiece W is treated as a characteristic part 50. In the following, the quantity of the characteristic part 50 is described to be one in order to facilitate description, but alternatively, the number of the characteristic parts 50 may be more than one. In the example configuration of FIG. 2, a protrusion of a circular pillar shape which protrudes from a surface of the workpiece W in the Z direction is set as the characteristic part 50.

Thus, in the present embodiment, the placement information includes a position of a center of gravity PGr of the reference workpiece Wr, a relative position of a characteristic part 50r with respect to the center of gravity PGr, and a size of the characteristic part 50r. The relative position of the characteristic part 50 with respect to the center of gravity PG is represented by a direction angle of the characteristic part 50 as viewed from the center of gravity PG (hereinafter also called a “characteristic part angle A”), and a distance from the center of gravity PG to the characteristic part 50 (hereinafter also called a “characteristic part distance L”). In the following, a size of the characteristic part 50 will be called a “characteristic part size C”. The coordinate system used when the angle is determined is a linear orthogonal coordinate system (that is, a Cartesian coordinate system).

When the placement of the workpiece to be measured Wm is to be identified, the controller 30 controls the imaging unit 12 to acquire a position identifying image 70 capturing an image of the workpiece to be measured Wm. The controller 30 then analyzes the position identifying image 70, to identify a position of a center of gravity PGm of the workpiece to be measured Wm, and a characteristic part angle Am. When the image of the workpiece to be measured Wm is ideally captured, a position error between the center of gravity PGm of the workpiece to be measured Wm and the center of gravity PGr of the reference workpiece Wr, and an angle error between the characteristic part angle Am of the workpiece to be measured Wm and a characteristic part angle Ar of the reference workpiece Wr become the amount of offset representing the placement error of the workpiece to be measured Wm.

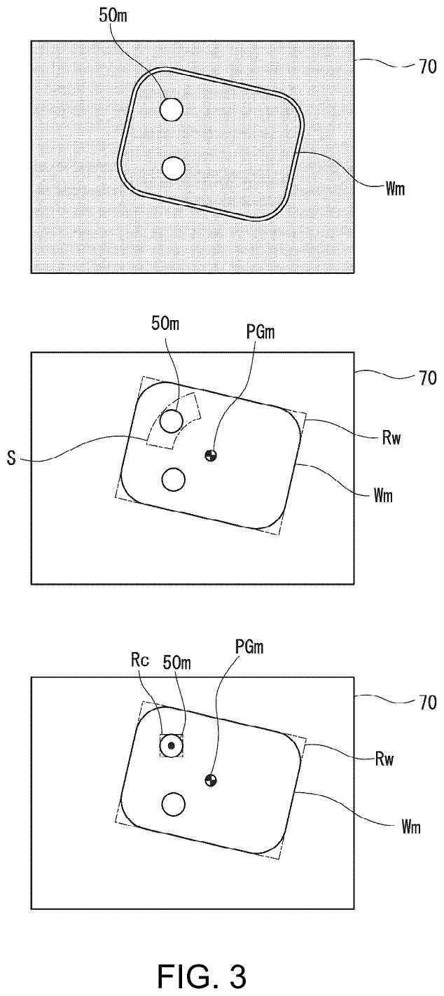

However, because various disturbances occur in the imaging environment of the workpiece to be measured Wm, it is difficult to ideally capture the image of the workpiece to be measured Wm. As a result, normally, in many cases, each of the position of the center of gravity PGm and the characteristic part angle Am acquired through a simple image analysis includes a certain degree of error. This point will now be described with reference to FIG. 3 to FIG. 5. First, a procedure for extracting the center of gravity PGm and the characteristic part 50m from the position identifying image 70 will be briefly described with reference to FIG. 3. FIG. 3 is a schematic diagram showing extraction of the center of gravity PGm and the characteristic part 50m.

When the center of gravity PGm and the characteristic part 50m of the workpiece to be measured Wm are to be extracted, the controller 30 first applies a binarization process on the position identifying image 70 acquired by capturing an image of the workpiece to be measured Wm. More specifically, the controller 30 converts the position identifying image 70 into grayscale and applies a binarization process with an arbitrary threshold. The grayscale conversion is performed, for example, through an NTSC weighted average method. The controller 30 may further apply processes such as enlargement and reduction of the image, edge enhancement, or the like as necessary, before the binarization process.

After the binarization process, the controller 30 negative-positive inverts the binarized image. An upper part of FIG. 3 is a schematic diagram of the negative-positive-inverted image. At the upper part of FIG. 3, for easier viewing of the reference numerals or the like, a black portion is not filled, and a gray hatching is applied instead.

Then, the controller 30 applies a blob processing on the negative-positive-inverted image. In the actual practice, the blob processing is applied to the negative-positive-inverted image, but a middle part and a lower part of FIG. 3 show images without the negative-positive inversion, for ease of viewing.

A blob means a collected assembly of pixels having the same concentration. The controller 30 extracts the blob in the negative-positive-inverted image. For the blob processing, techniques of the related art can be employed, and thus, the blob processing will not be described in detail herein. In any case, through the blob processing, a plurality of blobs is extracted.

For each of the plurality of blobs which are extracted, the controller 30 identifies a quadrangle of the minimum size which contains the blob. The controller 30 identifies a quadrangle of the maximum size among the plurality of quadrangles which are identified as a “workpiece-containing quadrangle Rw” which contains an outer form line of the workpiece to be measured Wm. The controller 30 calculates a center position of the workpiece-containing quadrangle Rw as the center of gravity PGm of the workpiece to be measured Wm. The middle part of FIG. 3 shows the identification of the workpiece-containing quadrangle Rw and the center of gravity PGm.

The controller 30 also identifies a quadrangle which contains the blob corresponding to the characteristic part 50m as a “characteristic part-containing quadrangle Rc”.

In order to identify the characteristic part-containing quadrangle Rc, the controller 30 uses characteristic information of the reference workpiece Wr (that is, the characteristic part angle Ar, a characteristic part distance Lr, and a characteristic part size Cr of the reference workpiece Wr). Based on the characteristic part angle Ar and the characteristic part distance Lr of the reference workpiece Wr, the controller 30 identifies an approximate range in which the characteristic part 50m of the workpiece to be measured Wm is present as a search range S (refer to the middle part of FIG. 3). The controller 30 identifies, among the blobs present in this search range S, a blob having an angle, a distance, and a size similar to the characteristic part angle Ar, the characteristic part distance Lr, and the characteristic part size Cr of the reference workpiece Wr, as the characteristic part 50m of the workpiece to be measured Wm.

When there is no suitable blob in the search range S, it may be considered that a workpiece W different from a workpiece W intended by the user is placed. In this case, the controller 30 notifies the user of an error indicating a target mismatch and completes the placement identifying process.

Once the controller 30 identifies the blob of the characteristic part 50m, the controller 30 determines a quadrangle of the minimum size containing the blob as the characteristic part-containing quadrangle Rc (refer to the lower part of FIG. 3). The controller 30 then calculates a direction angle of the center of the characteristic part-containing quadrangle Rc viewed from the center of gravity PGm as the characteristic part angle Am of the characteristic part 50m.

When an ideal position identifying image 70 is acquired, the center of gravity PGm and the characteristic part angle Am of the workpiece to be measured Wm thus calculated become the information indicating the placement of the workpiece to be measured Wm. That is, an amount of position deviation between the center of gravity PGr and the center of gravity PGm, and an amount of angle deviation between the characteristic part angle Ar and the characteristic part angle Am become the amount of offset of the workpiece to be measured Wm.

As is clear from the above description, in the present embodiment, the center of gravity PGm and the characteristic part 50m of the workpiece to be measured Wm are extracted based on the binarized image of the position identifying image 70. However, in the binarized image of the position identifying image 70, errors due to shaking or the like of the camera 14 and the illuminator 16 tend to be contained. When the position of the center of gravity PGm and the characteristic part angle Am are calculated based on the binarized image containing such errors, the position of the center of gravity PGm and the characteristic part angle Am which are ultimately acquired would also include errors. In addition, there is a slight individual difference in the workpiece to be measured Wm, and the workpiece to be measured Wm does not completely match the shape of the reference workpiece Wr. It is not possible to compensate for such a slight individual difference through the image analysis alone.

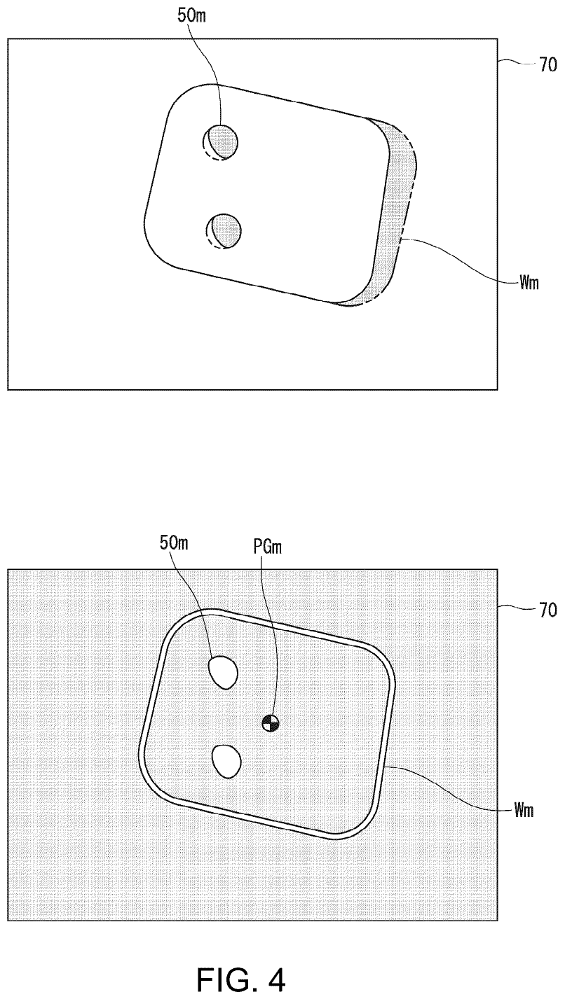

For example, a case will be considered in which, as shown in an upper part of FIG. 4, due to shaking or the like of the camera 14 and the illuminator 16, a strong shadow or reflection occurs at an end of the workpiece to be measured Wm and the characteristic part 50m. In this case, the workpiece to be measured Wm actually has an edge shown with a two-dots-and-a-chain line, but due to influences of the shadow and the reflection, an edge shown by a solid line would be extracted when the binarization process is applied. A lower part of FIG. 4 shows a negative-positive-inverted image generated based on the binarized image containing these errors. When the center of gravity PGm and the characteristic part angle Am are determined based on the binarized image containing errors, naturally, errors occur also in the center of gravity PGm and the characteristic part angle Am. Even if an image the workpiece to be measured Wm is ideally captured, if there is a slight individual difference in the shape of the workpiece to be measured Wm, the individual difference cannot be appropriately treated by the image analysis alone. As a result, an appropriate amount of offset cannot be set, possibly resulting in the interference between the movable part and the workpiece W and reduction of the precision of the product.

In consideration of this, in the present embodiment, the reference image 60 is prepared in advance, and the errors are resolved using the reference image 60. This process will now be described in detail.

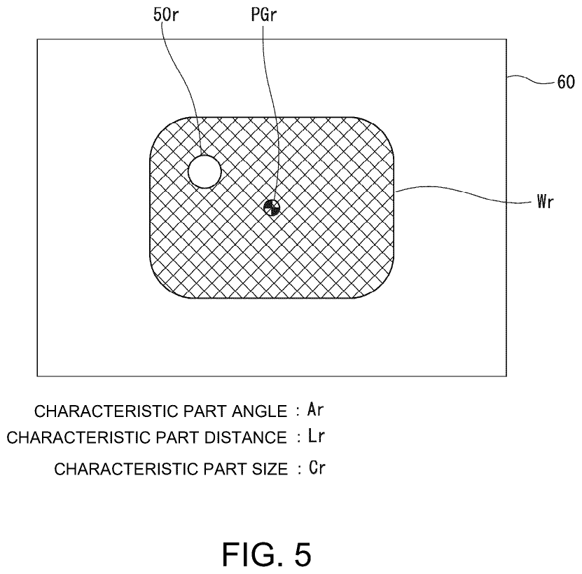

FIG. 5 is a diagram showing an example of the reference image 60. The reference image 60 is an image representing a shape of the reference workpiece Wr, in particular, an outer form and the characteristic part 50r of the reference workpiece Wr. As described, the reference workpiece Wr is a workpiece having a known placement. The reference image 60 is a mask image in which portions other than the characteristic part 50r are masked. Therefore, in the portions of the reference image 60 other than the characteristic part 50r, the shape of the reference workpiece Wr is eliminated. In FIG. 5, for the purpose of explanation, the center of gravity PGr is shown, but in the actual reference image 60, the center of gravity PGr is not shown.

As will be described in detail later, the reference image 60 is overlapped over the position identifying image 70, to thereby form the overlap image 80. The reference image 60 is transparent to an extent that the shape of the workpiece to be measured Wm imaged in the position identifying image 70 is visible.

The reference image 60 is prepared for each type of the workpiece W. Further, to the reference image 60, a position of the center of gravity PGr, the characteristic information (that is, the characteristic part angle Ar, the characteristic part distance Lr, and the characteristic part size Cr), and the machining information (that is, the NC program or the like) are linked.

Such a reference image 60 may be generated, for example, based on an image acquired by capturing an image of a reference workpiece Wr which actually exists. In this case, the user first fixes the workpiece W on the table 106 in the machining chamber 102, and precisely measures the position and the angle of the workpiece W. For example, after the user fixes the workpiece W in the machining chamber 102, the user may measure the position and the angle of the workpiece W using a sensor such as a touch probe. Alternatively, the user may fix the workpiece W on a pallet outside of the machining chamber 102 and measure the position of the workpiece W on the pallet. In this case, the position and the angle of the workpiece W in the machining chamber 102 become known by the user fixing the pallet in the machining chamber 102 without any deviation in the position or the angle. When the position and the angle in the machining chamber 102 become known, the workpiece W can be handled as the reference workpiece Wr.

When the reference workpiece Wr is set in the machining chamber 102, the controller 30 drives the imaging unit 12, and acquires a captured image of the reference workpiece Wr. For example, the controller 30 may capture images of the reference workpiece Wr a plurality of times while changing the imaging condition (for example, drive conditions of the camera 14 and the illuminator 16). In this case, a plurality of captured images that are acquired may be combined into one image in order to allow more accurate extraction of the outer form and the characteristic part 50r of the reference workpiece Wr through the image analysis. Alternatively, when an image from which the outer form and the characteristic part 50r of the reference workpiece Wr can be extracted can be acquired with imaging of one time, the number of imaging operations may be one. In any case, when a suitable captured image is acquired, the captured image is processed, to generate the reference image 60.

For example, using an arbitrary drawing application (for example, Microsoft Paint, where “Microsoft” is a registered trademark), the user may black out portions of the captured image of the reference workpiece Wr other than the characteristic part 50r, and may give transparency to the blacked-out image, to generate a mask image as the reference image 60. The degree of transparency of the reference image 60 may be uniform or may be different between the characteristic part 50r and the other portions.

The controller 30 also extracts the center of gravity PGr and the characteristic part 50r of the reference workpiece Wr from the captured image of the reference workpiece Wr. More specifically, the controller 30 applies the grayscale conversion, the binarization process, the negative-positive inversion process, and the blob processing on the captured image of the reference workpiece Wr. The controller 30 then extracts a quadrangle which contains the largest blob as the workpiece-containing quadrangle Rw. The controller 30 calculates a center of the workpiece-containing quadrangle Rw as the center of gravity PGr of the reference workpiece Wr.

The controller 30 also presents the image after the blob processing to the user and asks the user to select a blob to be used as the characteristic part 50r. When the user selects a certain blob, the controller 30 extracts a containing quadrangle of the selected blob as the characteristic part-containing quadrangle Rc. The controller 30 then calculates the center of the characteristic part-containing quadrangle Rc as the position of the characteristic part 50r, and calculates, based on the position, the characteristic information; that is, the characteristic part angle Ar, the characteristic part distance Lr, and the characteristic part size Cr of the reference workpiece Wr. The controller 30 stores these acquired values in the memory 34, in correlation with the reference image 60.

As another configuration, the reference image 60 may be generated based not on the captured image of the reference workpiece Wr, but rather, on CAD data or a design drawing of the reference workpiece Wr. In this case, the controller 30 may generate a schematic plan view of the reference workpiece Wr based on the CAD data or the design drawing of the reference workpiece Wr and may process the plan view to generate the reference image 60. In addition, the controller 30 may calculate the position of the center of gravity PGr, the characteristic part angle Ar, the characteristic part distance Lr, and the characteristic part size Cr of the reference workpiece Wr, based on the plan view.

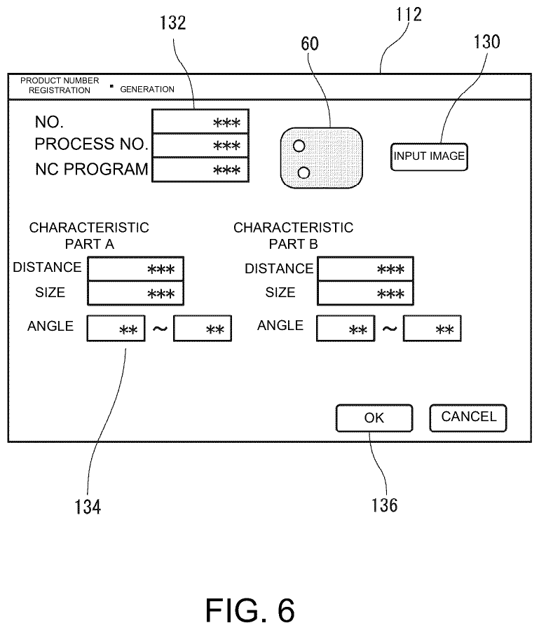

FIG. 6 is a diagram showing a case example of a registration screen 112 of the reference image 60. The registration screen 112 is displayed on the display of the UI apparatus 18. In the example configuration of FIG. 6, the user presses an image loading button 130, to select a reference image 60 which is generated in advance. The selected reference image 60 is displayed on the registration screen 112. In addition, in the example configuration of FIG. 6, as machining information 132, a product number of the workpiece W, a machining process number of the machining process applied on the workpiece W, and identification information of the NC program applied to the workpiece W are set. Such machining information 132 may be manually input by the user or may be invoked by reading the identification information (for example, a barcode) attached to the workpiece W, by means of the input device 22 (for example, a barcode scanner). In addition, on the registration screen 112, characteristic information 134 linked to the reference image 60 is displayed. FIG. 6 shows a case with two characteristic parts 50r. When there is no problem in the displayed information, the user presses an OK button 136, to register the reference image 60 in correlation with the characteristic information and the machining information.

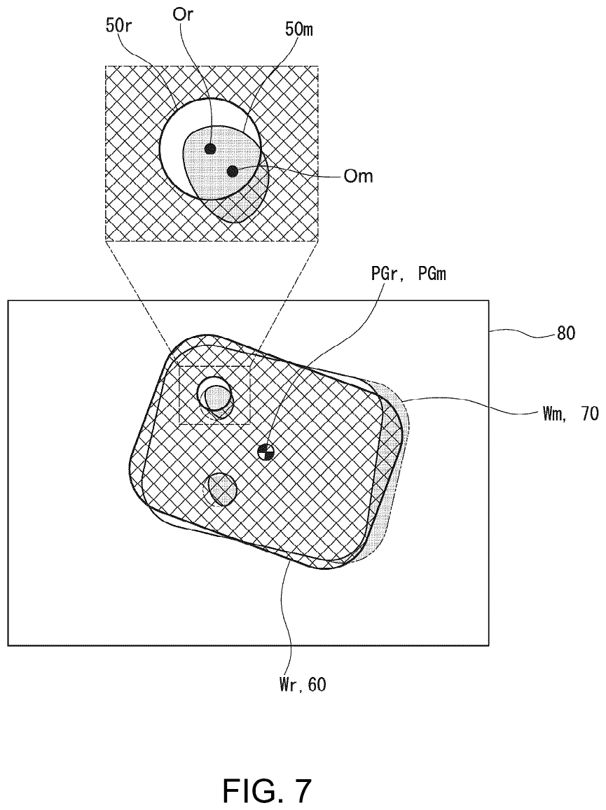

Next, the principle of placement identification of the workpiece to be measured Wm using such a reference image 60 will be described. As described above, when the placement of the workpiece to be measured Wm is to be identified, the controller 30 captures an image of the workpiece to be measured Wm and acquires the position identifying image 70. The controller 30 further calculates the position of the center of gravity PGm and the characteristic part angle Am of the workpiece to be measured Wm based on images acquired by binarizing and inverting the negative and positive of the position identifying image 70. However, as described above, normally, the center of gravity PGm and the characteristic part angle Am include errors. In order to easily correct the errors, the controller 30 generates the overlap image 80 which is an image in which the reference image 60 is overlapped over the position identifying image 70. FIG. 7 is a diagram showing an example of the overlap image 80.

When generating the overlap image 80, the controller 30 preliminarily adjusts the reference image 60 in advance, based on a position error of the center of gravity PG and an angle error of the characteristic part 50 between the reference workpiece Wr and the workpiece to be measured Wm. That is, the controller 30 preliminarily adjusts the position of the reference image 60 such that the center of gravity PGr of the reference workpiece Wr coincides with a provisional center of gravity PGm of the workpiece to be measured Wm determined from the negative-positive-inverted image of the position identifying image 70. In addition, the controller 30 preliminarily adjusts the angle of the reference image 60 such that the characteristic part angle Ar of the reference workpiece Wr coincides with a provisional characteristic part angle Am of the workpiece to be measured Wm determined from the binarized image of the position identifying image 70. The controller 30 then generates the overlap image 80 by overlapping the reference image 60 after the preliminary adjustment over the position identifying image 70.

The generated overlap image 80 is presented to the user. Here, the position identifying image 70 is an image before binarization, and thus has a sufficient gradation. Therefore, even if a strong shadow or reflection occurs in the reference workpiece Wr imaged in the position identifying image 70, the user can understand the shape of the reference workpiece Wr.

That is, the user can understand the shapes and the positions of the workpiece to be measured Wm and the reference image 60, by viewing the overlap image 80. In particular, in the present embodiment, the reference image 60 is a mask image in which portions other than the characteristic part 50r are masked, and which has a certain degree of transparency. Because of this, the user can clearly understand the shapes of portions of the workpiece to be measured Wm which overlap the reference workpiece Wr. As a result, the user can easily recognize deviations in the position and the angle of the reference image 60 with respect to the workpiece to be measured Wm. After the controller 30 presents the overlap image 80 to the user, the controller 30 asks the user to finely adjust the position and the angle of the reference image 60.

The user finely adjusts the position and the angle of the reference image 60 while viewing the overlap image 80 displayed on the display, so that the reference image 60 accurately overlaps the workpiece to be measured Wm. Specifically, the user manipulates the input device 22 such as the keyboard, to command an amount of movement and an amount of rotation of the reference image 60. The controller 30 continuously reflects in the overlap image 80 the amount of correction which is input by the user. When the reference image 60 accurately overlaps the workpiece to be measured Wm through the fine adjustment, the user commands calculation of the position and the angle of the workpiece to be measured Wm.

Upon receiving this command, the controller 30 calculates the position of the center of gravity PGr and the characteristic part angle Ar of the reference image 60 after the fine adjustment, and presumes these values as the true position of the center of gravity PGm and the true characteristic part angle Am of the workpiece to be measured Wm. The controller 30 then calculates an amount of offset of the workpiece to be measured Wm based on the true position of the center of gravity PGm and the true characteristic part angle Am and transmits the amount of offset to the NC apparatus 110.

In this manner, by the user understanding the actual shape of the workpiece to be measured Wm finely adjusting the position and the angle of the reference image 60, the position and the angle of the workpiece to be measured Wm can be identified more accurately. In addition, by preliminarily adjusting the position and the angle of the reference image 60 before the fine adjustment by the user, the amount of fine adjustment by the user can be reduced, and the effort and time required for the fine adjustment can be significantly reduced. Further, as described above, the reference image 60 is a mask image in which portions other than the characteristic part 50r are masked, and which has a certain degree of transparency. Therefore, the user can appropriately recognize the shape of the workpiece to be measured Wm even on the overlap image 80 and can thus easily finely adjust the reference image 60.

Alternatively, a configuration may be employed in which, when the amount of deviation of position between the characteristic part 50r in the reference image 60 and the characteristic part 50m in the position identifying image 70 is less than or equal to a predefined allowable value at the stage after the preliminary adjustment, the controller determines the true position and the true angle of the workpiece to be measured Wm without requesting the fine adjustment. For example, as shown in FIG. 7, the controller 30 identifies a center point Or of the characteristic part 50r and a center point Om of the characteristic part 50m at the stage after the preliminary adjustment, and determines a distance between the two points Or and Om. The controller 30 may then request the fine adjustment to the user only when the determined distance is greater than or equal to the predefined allowable value.

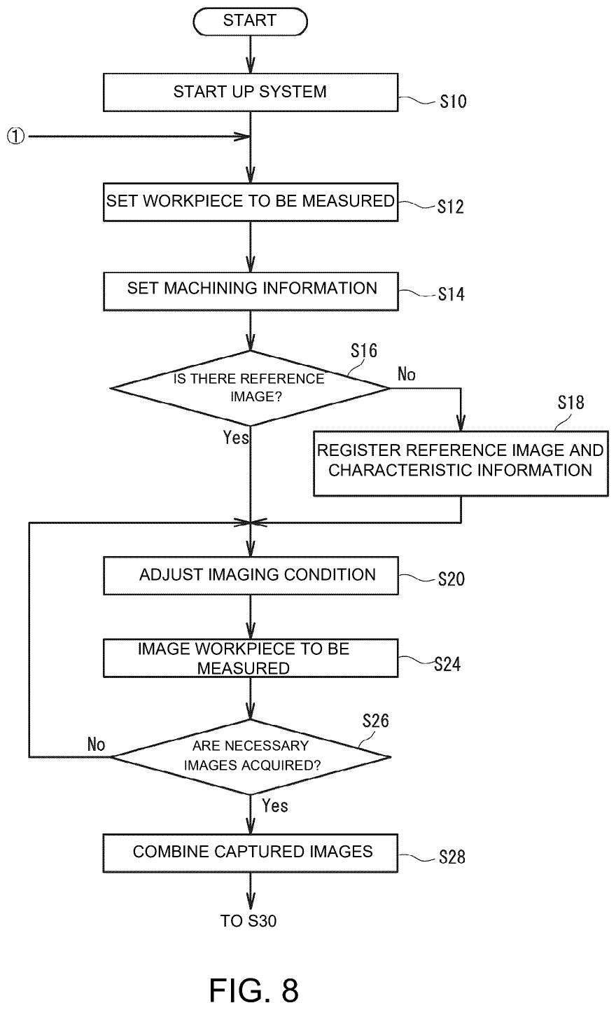

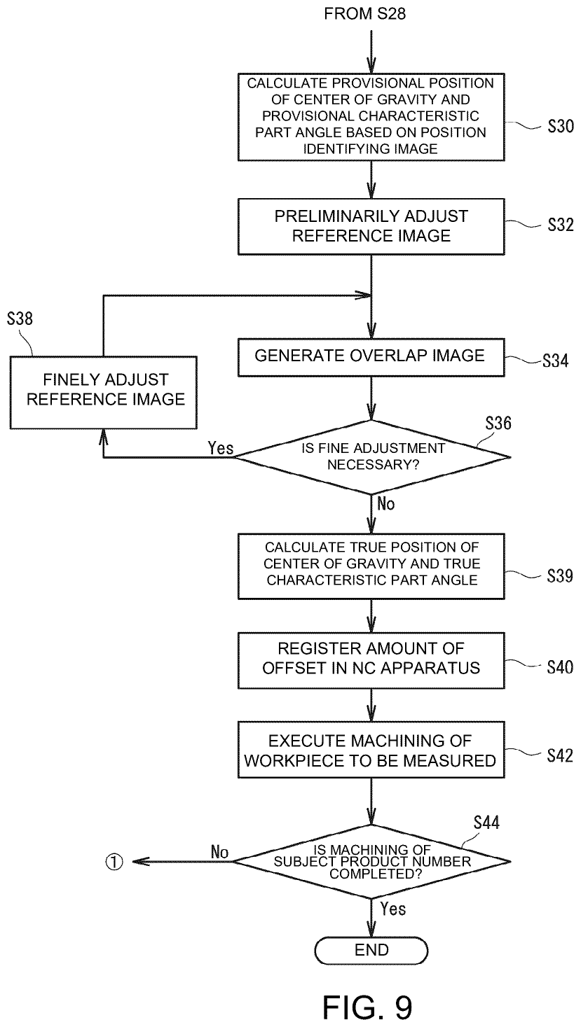

Next, a procedure of machining of the workpiece to be measured Wm by the machine tool 100 will be described with reference to FIG. 8 and FIG. 9. When the workpiece to be measured Wm is to be machined by the machine tool 100, the user starts up and initializes the machine tool 100 and the placement identifying apparatus 10 (S10). In the initialization, communication is established between the controller 30 and the NC apparatus 110, and between the controller 30 and the imaging unit 12. In addition, the controller 30 acquires a transform parameter between the camera coordinate system and the machine coordinate system. For example, the controller 30 captures an image of a reference region having a known position and a known size (for example, a mark attached to the origin of the machine coordinate system) by means of the camera 14 and identifies the transform parameter of the coordinate systems based on the position and the size of the reference region in the acquired image.

Then, the user places and fixes the workpiece to be measured Wm on the table 106 in the machining chamber 102 (S12). In this process, the positioning of the workpiece to be measured Wm does not need to be precise, and positioning by human eyes is sufficient.

Then, the user inputs machining information corresponding to the workpiece to be measured Wm (S14). The machining information includes, for example, the product number of the workpiece to be measured, a process number of a process to be executed next, the NC program name, or the like. The machining information may be manually input by the user by manipulating the keyboard or the like. Alternatively, identification information (for example, a barcode) of the machining information may be attached in advance to the workpiece to be measured Wm or the fixation jig, and the controller 30 may read the identification information.

The controller 30 checks presence or absence of a reference image 60 correlated to the input machining information (S16). When there is no corresponding reference image 60, the controller 30 prompts the user to register a reference image 60. In this case, the user invokes the registration screen 112 shown in FIG. 6 and registers the reference image 60 and the characteristic information through the registration screen 112 (S18).

After the reference image 60 is registered, the controller 30 starts imaging of the workpiece to be measured Wm (S20˜S26). Specifically, the controller 30 adjusts an imaging condition (S20). The imaging condition includes a condition related to the camera 14 and a condition related to the illuminator 16. The condition related to the camera 14 is, for example, a position, shutter speed, automatic white balance, or the like of the camera 14. The condition related to the illuminator 16 is, for example, a position, brightness, color temperature, or the like of the illuminator 16. These imaging conditions are set and registered in advance. When the adjustment of the imaging condition is completed, the controller 30 drives the imaging unit 12, to capture an image of the workpiece to be measured Wm (S24). The acquired image is temporarily stored in the memory 34. Then, the controller 30 repeats the imaging of the workpiece to be measured Wm while changing the imaging condition until a necessary number of images are acquired (S20˜S26).

When the necessary number of images are acquired, the controller 30 combines this plurality of images, to generate one position identifying image 70 (S28). In this case, the controller 30 extracts, from each of the plurality of captured images, a portion in which an image of the workpiece to be measured Wm is clearly captured and combines the extracted portions. For example, when a first captured image acquired in a state in which the illuminator 16 (refer to FIG. 1) is applied from a left side of the workpiece to be measured Wm and a second captured image acquired in a state in which the illuminator 16 is applied from a right side of the workpiece to be measured Wm are to be combined, a left half of the first captured image and a right half of the second captured image are combined. By employing such a configuration, the entirety of the workpiece to be measured Wm becomes bright, and shading due to unevenness on the workpiece to be measured Wm becomes clearer, and an image which can be easily analyzed can thus be acquired. If an appropriate image can be acquired, the number of imaging operations may be one, in which case, obviously, the combining process of the images (S28) is skipped.

Next, the controller 30 extracts the center of gravity PGm and the characteristic part 50m of the workpiece to be measured Wm based on the acquired position identifying image 70 and calculates a provisional position of the center of gravity PGm and a provisional characteristic part angle Am (S30). Then, the controller 30 preliminarily adjusts the position and the angle of the reference image 60 based on the provisional position of the center of gravity PGm and the provisional characteristic part angle Am that are acquired (S32).

The controller 30 overlaps the reference image 60 after the preliminary adjustment over the position identifying image 70, to generate the overlap image 80 (S34). The controller 30 then judges whether or not fine adjustment of the reference image 60 is necessary (S36). For example, if a command indicating that the fine adjustment is not necessary is received from the user, the controller 30 proceeds to step S39. Alternatively, the controller 30 may judge whether or not the fine adjustment is necessary based on the amount of deviation of the position between the center of the characteristic part 50m of the workpiece to be measured Wm and the center of the characteristic part 50r of the reference workpiece Wr in the overlap image 80. When the amount of deviation of the position is less than or equal to an allowable value which is defined in advance, the controller 30 judges that the fine adjustment is not necessary and proceeds to step S39.

On the other hand, when the controller 30 judges that the fine adjustment is necessary, the controller 30 displays the overlap image 80 on the display and requests the user to finely adjust the reference image 60. If the user commands the fine adjustment of the position and the angle of the reference image 60 in response to this request, the controller 30 corrects the position and the angle of the reference image 60 according to the command, and again generates (re-generates) the overlap image 80 (S38, S34). The re-generated overlap image 80 is displayed on the display.

The user or the controller 30 judges whether or not a further fine adjustment is necessary based on the re-generated overlap image 80 (S36). When it is finally judged that no further fine adjustment is necessary, the controller 30 presumes the center of gravity PGr and the characteristic part angle Ar of the reference workpiece Wr included in the reference image 60 in the overlap image 80 as the true center of gravity PGm and the true characteristic part angle Am of the workpiece to be measured Wm, and calculates the placement of the workpiece to be measured Wm (S39).

Then, the controller 30 calculates the amount of offset based on the true position and the true angle of the workpiece to be measured Wm that are calculated and registers the amount of offset in the NC apparatus 110 (S40). The NC apparatus 110 controls the movable part of the machine tool 100 while reflecting the registered amount of offset and executes the machining of the workpiece to be measured Wm (S42). When all of machining of the workpiece W which is to be machined according to the current machining information is completed (Yes in S44), the procedure is completed.

As is clear from the above description, according to the technique of the present embodiment, an accurate position and an accurate angle of the workpiece to be measured Wm are identified after the workpiece to be measured Wm is set and before the machining of the workpiece to be measured Wm is started. As a result, the amount of offset can be accurately calculated, and interference between the movable part and the workpiece to be measured Wm can be effectively prevented. In addition, the position and the angle of the workpiece to be measured Wm are adjusted through a combination of the image analysis and the fine adjustment by the user. As a result, the position and the angle can be accurately calculated while reducing the effort and the time of the user.

The structure described above is merely exemplary, and so long as the structure described in claim 1 is provided, the other structures may be suitably modified. For example, in the above description, the number of the characteristic parts 50 is described as one, but alternatively, the number of characteristic parts 50 which are set on one target may be more than one. Further, a reference point serving as a reference of the position of the target is not limited to the center of gravity PG and may be other points. For example, the reference point may be the center point O of one characteristic part 50, or a corner of the outer form of the workpiece W. The characteristic part angle A is not limited to the direction angle of the characteristic part 50 as viewed from the center of gravity PG as described above and may alternatively be the direction angle of one characteristic part 50 as viewed from another characteristic part 50.

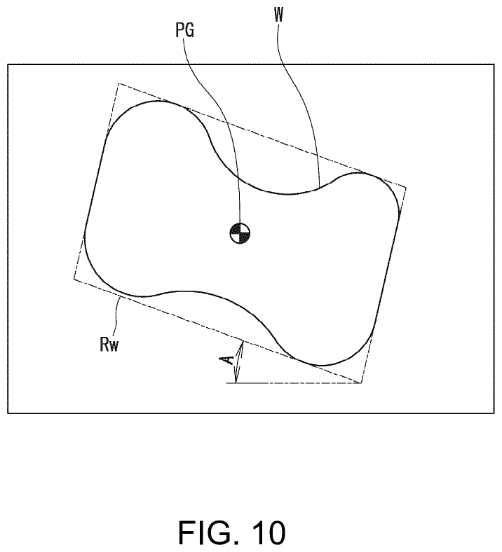

Moreover, in the above description, the characteristic part 50 is described as a shape part inside the outer form of the workpiece W. However, depending on the workpiece W, there may be cases in which an upper surface of the workpiece W is flat, and there is no characteristic shape part. For example, in the case in which there is no specific characteristic part 50 inside the workpiece W as shown in FIG. 10, the outer form of the workpiece W itself may be treated as the characteristic part 50. In this case, the angle of the workpiece W is defined by an angle of inclination of the outer form of the workpiece W. Therefore, for example, an angle of an edge of the outer form of the workpiece W, or an angle of inclination of the quadrangle of the minimum size containing the workpiece W may be treated as the characteristic part angle A. Furthermore, in the above description, the position and the angle of the workpiece W are determined as the placement. However, in a case of a workpiece W having a circular shape and not having a characteristic unevenness, the position alone may be determined as the placement.

### REFERENCE SIGNS LIST

10 placement identifying apparatus, 12 imaging unit, 14 camera, 16 illuminator, 18 UI apparatus, 20 output device, 22 input device, 30 controller, 32 processor, 34 memory, 50 characteristic part, 60 reference image, 70 position identifying image, 80 overlap image, 100 machine tool, 102 machining chamber, 104 spindle head, 106 table, 110 NC apparatus, 112 registration screen, 130 image loading button, A characteristic part angle, C characteristic part size, L characteristic part distance, PG center of gravity, W workpiece.

1. A placement identifying apparatus comprising:
a camera that captures an image of a target which is placed in a predetermined area;
an UI apparatus that presents information to a user and that receives a manipulation command from the user; and
a controller configured to identify a placement of a measurement target, which is a target which is set at an arbitrary placement, based on an image captured by the camera, wherein
the controller is configured to:
store in advance a reference image representing a shape of a reference target which is a target which is set at a known placement;
acquire a position specifying image by causing the camera to capture an image of the measurement target;
identify a provisional placement of the measurement target based on the position identifying image;
preliminarily adjust a position and an angle of the reference image based on the provisional placement so that the reference target represented in the reference image overlaps the measurement target, and generate an overlap image which is an image in which the reference image is overlapped over the position identifying image;
present the overlap image to the user, and receive from the user a command of fine adjustment for the position and the angle of the reference image; and
identify a true placement of the measurement target based on the position and the angle of the reference image after the fine adjustment.

2. The placement identifying apparatus according to claim 1, wherein
the target has a reference point and one or more characteristic parts, and
the controller is further configured to define a position of the target with reference to the reference point and define an angle of the target with reference to the one or more characteristic parts.

3. The placement identifying apparatus according to claim 2, wherein
the reference point is a center of gravity of the target,
each of the one or more characteristic parts is a shape part which is present in an outer form of the target, and which can be distinguished from a periphery thereof, and
the controller is further configured to define the angle of the target by a direction angle of each of the one or more characteristic parts as viewed from the reference point or another characteristic part.

4. The placement identifying apparatus according to claim 3, wherein
the reference image is transparent to an extent that the position identifying image is visible in the overlap image.

5. The placement identifying apparatus according to claim 4, wherein
the reference image is a mask image in which portions other than the one or more characteristic parts in the reference target are masked.

6. The placement identifying apparatus according to claim 2, wherein
the controller is further configured to identify an amount of deviation between each of the one or more characteristic parts of the measurement target and a respective one of the one or more characteristic parts of the reference target in the overlap image, and to identify, when the amount of deviation is less than a predefined allowable value, the true placement of the measurement target based on the position and the angle of the reference image after the preliminary adjustment, without presenting the overlap image to the user.

7. The placement identifying apparatus according to claim 2, wherein
the controller is further configured to:
store a size of the characteristic part and a relative position of the characteristic part with respect to the reference point in the reference target as characteristic information;
identify a search range of the characteristic part of the measurement target in the position identifying image based on the characteristic information; and
output a target mismatch error when no shape matching the characteristic information is found in the search range of the position identifying image.

8. The placement identifying apparatus according to claim 2, wherein
the one or more characteristic parts are an outer form of the target, and
the controller is further configured to define the angle of the target by an angle of inclination of the outer form of the target.

9. The placement identifying apparatus according to claim 1, wherein
the controller is further configured to calculate the provisional placement of the measurement target based on an image acquired by binarizing the position identifying image.

10. The placement identifying apparatus according to claim 1, wherein
the predetermined area is a machining chamber of a machine tool, and
the target is a workpiece which is fixed in the machining chamber, and which is to be machined by the machine tool.
